(19) United States
(12) Patent Application Publication
(10) Pub. No.: US 2021/0298877 A1
(43) Pub. Date: Sep. 30, 2021

(54) FASTENER AND METHOD OF INSTALLATION

(71) Applicant: Michael Remo, Clearwater, FL (US)

(72) Inventor: Michael Remo, Clearwater, FL (US)

(21) Appl. No.: 16/915,873

(22) Filed: Jun. 29, 2020

Related U.S. Application Data
(60) Provisional application No. 63/003,175, filed on Mar. 31, 2020.

(51) Int. Cl. A61C 8/00

(52) U.S. Cl. CPC A61C 8/0028; A61C 2008/0046; A61C 8/0037

(57) ABSTRACT

The invention is a fastener for medical or dental use which requires minimal preparation of a site in bone. According to one embodiment the fastener includes a shank and a head having an aperture with a torque-receiving aperture such as a threaded hole or a polygon such as a hex-sided hole. The other end of the shank is a blunt or a sharp point. Another embodiment includes a radially spaced apart series of strakes each having a linearly spaced apart series of barbs. An alternative embodiment includes on the shank a radially spaced apart series of linear arrays of barbs emerging from the shank itself. The linear spacings may be staggered from one radial line to the next so that as a whole the barbs are arranged into one or more continuous helicies.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### CROSS REFERENCE TO RELATED APPLICATION

This non-provisional utility application claims the benefit of and priority to U.S. provisional application Ser. 63/003,175 “Fastener,” filed 31 Mar. 2020. The entire contents of U.S. provisional application Ser. 63/003,175 “Fastener,” filed 31 Mar. 2020 is hereby incorporated into this document by reference.

### FIELD

The invention relates to a stud type fastener designed to be driven into a substrate material with minimal advance preparation of the substrate material.

### BACKGROUND

Some fasteners for cancellous or fibrous materials require advance preparation of a site on a receiving material, such as drilling a pilot hole in wood to receive a threaded fastener, or in the realm of biomedical studs installed into bone, a site may require abrusion to remove cortical bone and create a pocket of exposed cancellous bone. A bone graft would often be required. An interval of healing or monitoring the site for stability and lack of infection or other complication is often required between the preparation of the site and the installation of a stud.

Some biomedical fasteners which are designed to support a prosthesis require that an installed fastener does not typically receive a component that transfers forces or loads to the implant immediately. In this case the patient must endure having a vacancy at the site where the implant has been installed or an inconvenient temporary object installed as a proxy until the site has recuperated enough to support the intended prosthesis being attached to the implant.

Another existing practice for large molar root voids or for older people where osteoporosis is an issue sometimes includes sourcing additional material from cadaver bone to fill in the void or create sufficient local bone density to promote a solid anchoring structure around the implant. Cadaver bones from other bodies may not be accepted by the patient's body as compatible with itself, and rejection or other immune responses require subsequent expensive treatments and further attempts at reconstructing the tooth, and may also provoke inflammation, pain, and other undesirable conditions.

Although the medical community has spent many years attempting to adjust and refine drilling techniques to overcome lack of bone regrowth onto the implant, even with the drilling techniques of current practice, installing a drilled implant requires many weeks or months. These various preparatory steps cause unnecessary pain, delay, procedural cost, discomfort, foreboding, and worry on the part of a patient requiring a fastener implant. It would be beneficial to provide a fastener capable of more immediate installation and a procedure which promotes shorter recuperation intervals than the current art.

### BRIEF DESCRIPTION

A primary objective of the invention is to provide a fastener for medical or dental use which requires minimal preparation of a site in bone. A corollary objective of the invention is to provide a fastener which may be installed into a bone immediately following only modest initial preparation of a site on the bone. Another corollary objective of the invention is to reduce or eliminate intermediate preparation steps, or intervals where a patient endures a healing interval with a temporary hardware item only to re-experience additional wounding trauma during a final installation or fitting session for an implant capable of supporting a prosthetic.

Another objective of the invention is to provide a fastener with grippable features amenable to engagement and rapid formation of new bone tissue so that the fastener may begin its full-load, intended service role as soon as possible after installation. Another corollary objective of the invention is to reduce patient discomfort and anxiety by shortening the overall interval of time between a decision being made to install an implanted fastener for a prosthetic and the final, stable condition of living with an installed prosthetic. Yet another corollary objective of the invention is to reduce patient costs by eliminating intermediate visits to a dental clinic for intermediate stages of assembly steps, assessments, or adjustments as part of a long drawn out process for restoring the function of a strong tooth in its proper place.

Yet another objective of the invention is to provide a fastener designed to be inserted directly in an axial direction, with no preliminary drilling, and another corollary objective of the invention is to stimulate osteoblasts to begin calcification and new bone formation at the installation site immediately.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sublabel, it is intended to refer to all such multiple similar components.

FIG. 1 shows an oblique, top left front view of an embodiment of a fastener in accordance with the invention.

FIG. 2 shows an oblique, bottom left front view of the fastener of FIG. 1.

FIG. 3 shows an oblique, bottom left front view of an alternative embodiment of a fastener in accordance with the invention.

FIG. 4 shows a bottom view of the fastener of FIG. 3.

FIG. 5 shows an oblique view of an embodiment of a fastener in accordance with the invention having a hexagonal aperture as a torque receiving aperture.

FIGS. 6a through 6d show examples of barb profiles within the scope of the invention.

FIG. 7 shows a fastener in accordance with the invention in which a plurality of barbs are arranged on the shank to form a continuous helix.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise, and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The invention relates to a fastener for medical or dental use which requires minimal preparation of a site in bone. The fastener is designed to be inserted directly in an axial direction, with no preliminary drilling. Breaking small shards of bone and pushing them aside while the shaft is being inserted keeps them within the immediate vicinity of the implanted fastener, and increases local bone density by leaving small nodules of bone available for construction, and the immediate trauma activates ostoblasts to begin this construction (osteogenesis) immediately.

The looseness of these shards of bone allow them to move and backfill behind protuberances, undercuts, splines, barbs, and local cavities of the implant fastener to form an aggregate affording improved gripping strength once osteogenesis is complete.

According to one embodiment, the fastener includes a shank and a head having an aperture with a torque-receiving aperture such as a threaded hole or a polygon such as a hex-sided hole. The other end of the shank is a blunt or a sharp point. Another embodiment includes a radially spaced apart series of strakes each having a linearly spaced apart series of barbs. An alternative embodiment includes on the shank a radially spaced apart series of linear arrays of barbs emerging from the shank itself. The linear spacings may be staggered from one radial line to the next so that as a whole the barbs are arranged into one or more continuous helicies.

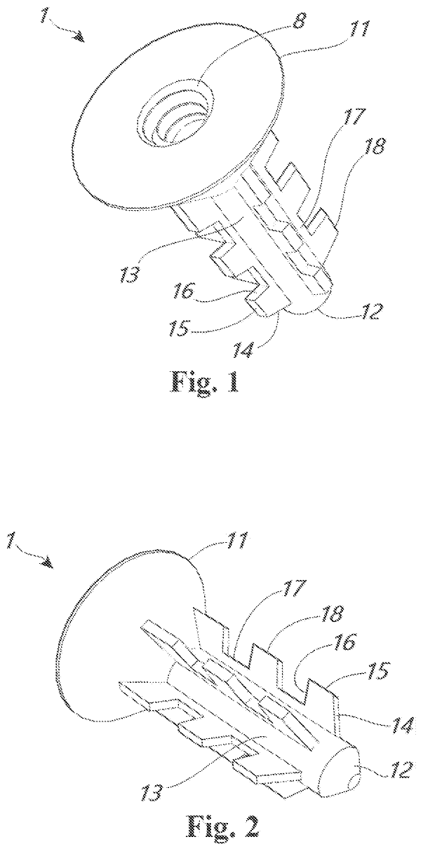

Referring to the figures, FIG. 1 shows an oblique, top left front view of an embodiment of a fastener [1] in accordance with the invention. The fastener includes a shank [13] with a head [11] at its first end and a point [12] at its second end, with the head further comprising a torque receiving aperture [8] which in this case is a blind aperture having threads. The shank defines an axis and a forward facing direction proceeding from the head to the point, and an aft facing direction opposite to the forward direction. The fastener further comprises a radially spaced apart series of linear arrays of barbs [18] spaced apart along the axis defined by the shank. Each barb in this embodiment has a face which is a leading edge [14,] a face which is a radially distal edge [15] also called a land, and a face which is a trailing edge [16.] For this embodiment, the barbs in any one linear array all arise from a common strake [17.]

FIG. 2 shows an oblique, bottom left front view of the fastener [1] of FIG. 1, showing the shank [13] extending from the head [11] to the point [12] along a longitudinal axis. A radially spaced apart array of strakes [17] each support a linear array of barbs [18.] Each barb in this embodiment has a face which is a leading edge [14,] a face which is a radially distal edge [15,] and a face which is a trailing edge [16,] except for the barbs nearest to the forward face of the head which merge with the head rather than including their own trailing edges. Each barb in any one of the linear arrays arises from a common strake emerging from the shank.

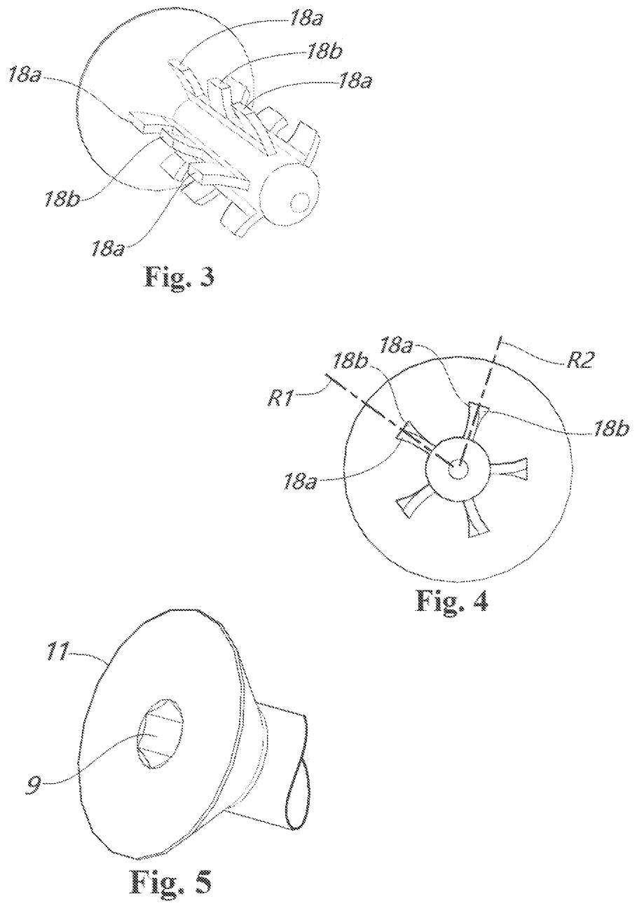

FIG. 3 shows an oblique, bottom left front view of an alternative embodiment of a fastener in accordance with the invention. In this embodiment the strakes are generally planar and each defines its own midplane. The planes of all the strakes are radially spaced apart about the longitudinal axis of the shank. The barbs in this embodiment are arcuate membranes which bend away from said midplanes of the strakes from which they arise. Although along any strake, all barbs may be fashioned to bend in the same direction, and even the entirety of all barbs on the fastener itself may be fashioned to bend in the same way, in a preferred embodiment barbs along a single strake alternatingly bend in opposed curvatures. Thus in this figure all barbs [18a] bend counterclockwise and barbs [18b] adjacent to them along the strake bend clockwise when views head on from the point of the shank.

FIG. 4 shows a bottom view of the fastener of FIG. 3, which is also a head on view from the point of the shank looking back toward the head of the fastener. [R1] and [R2] are radially spaced apart midplanes of the strakes seen in FIG. 3, and barbs along a single strake alternatingly bend in opposed curvatures. Thus in this figure all barbs [18a] bend counterclockwise and barbs [18b] adjacent to them along the strake bend clockwise when viewed head on from the point of the shank. According to an alternate embodiment, the arrays of barbs arise directly from the shank itself rather than from common strakes, and in this embodiment also, each and any one of the linear arrays of barbs defines a midplane which is a plane passing through the centerline axis of the shank, and each and any one barb within its linear array comprises an arcuate membrane bending away from the plane.

FIG. 5 shows an oblique view of an embodiment of a fastener in accordance with the invention having a hexagonal aperture [9] as a torque receiving aperture formed in the head [11] of the fastener.

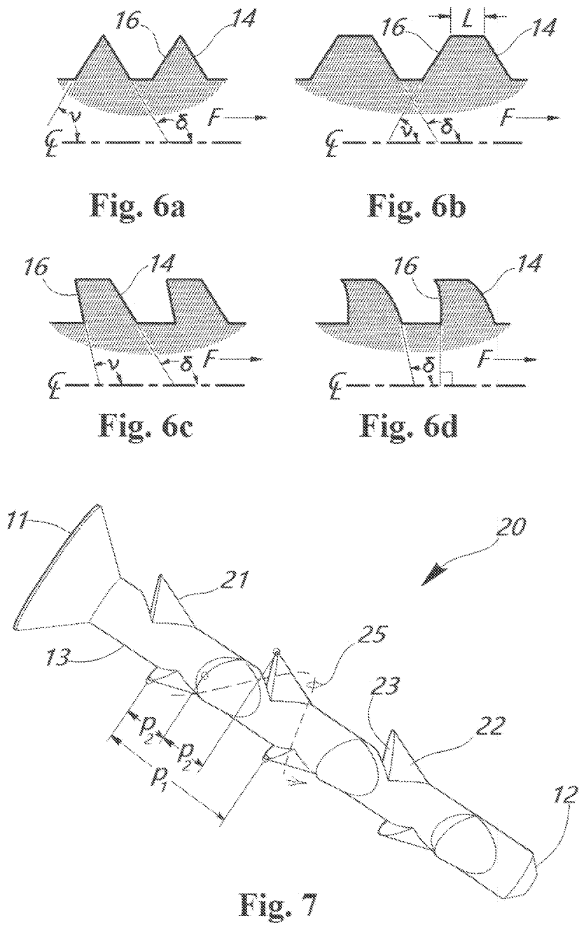

FIGS. 6a through 6d show examples of barb profiles within the scope of the invention. The center axis of the shank of the faster is shown in these figures by the traditional engineering centerline symbol [symbol] , and a forward direction is shown with the arrow [F.] A barb may include a profile of a shape selected from the set of shapes consisting of a triangle, a parallelogram, a square, a rectangle, and a rhomboid. In FIG. 6a, the profile shape is a triangle. The leading edge [14] and the trailing edge [16] meet at a point. A leading edge angle [δ] in this profile is an obtuse angle between the leading edge and the longitudinal axis, and is 90° more than a typical rake angle as defined for a typical cutting tool. The trailing edge has a trailing edge root angle [υ] which for a triangular tooth is also a clearance angle. In FIG. 6b the leading edge [14] and the trailing edge [16] are part of a parallelogram tooth profile which includes a land [L] and leading and trailing angles [δ] and [υ] as defined previously. A land may be parallel to the longitudinal axis as shown or it may also include a relief angle. In FIG. 6c, the barb profiles are a rhomboid. The leading and trailing edges [14] and [16] have leading and trailing angles [δ] and [υ] as defined previously, but the trailing edge angle is also an obtuse angle. In FIG. 6d, the leading edge [14] comprises a positively curved surface which may be a cylindrical, spherical, elliptical or ovoid surface. The trailing edge [16] comprises a negatively curved surface which may be a cylindrical, spherical, elliptical or ovoid surface of negative curvature. Generally, either or both the leading and trailing edges may comprise positively or negatively curved surfaces. In this embodiment shown the root angle of the trailing edge is a right angle.

FIG. 7 shows another embodiment of a fastener [20] in accordance with the invention having a head [11] and in which a plurality of barbs [21] are arranged on the shank [13] to form a continuous helix [25.] The point [12] of this fastener is a frustum. Each barb has a positively curved leading surface [22] and an undercut, negatively curved trailing surface [23.]

The barbs of the fastener are arranged in a plurality of linear arrays, wherein the number of which is [n.] The radial spacing between adjacent linear arrays is preferably an angle of (360°+n.) If the spacing pitch for barbs each linear array is a length dimension taken as [p₁,] then an axial offset between a first barb in a first linear array and a first barb in an radially adjacent second linear array is preferably a length dimension taken as [p₂] where the value of [p₂] is the value of [p₁]÷[n.] In such an arrangement the plurality of barbs thus arranged form a continuous helix. These dimensions may not be exact and may include variations for manufacturing tolerances.

A method for installing a dental implant as described herein may be understood as a procedure comprising the following steps with the following variations: First (a) unwanted tissue is removed to expose bone tissue at a desired installation site as determined by a medical practitioner operating on a patient. If necessary, infected tissue is removed if found at the installation site at this point. Then second (b) the installation site is irrigated with a disinfectant solution such as a saline or a medically indicated astringent solution.

Third (c) a fastener in accordance with the invention is provided. Such a fastener preferably comprises a shank with a head at its first end and a point at its second end, the head having a torque receiving aperture, while the shank defines an axis and also defines a forward facing direction proceeding from the head to the point and an aft facing direction opposite to the forward direction. The preferred fastener also includes a radially spaced apart series of linear arrays of barbs spaced apart along its axis. Fourth (d) an installation tool capable of imparting a linear impulse force to the fastener is provided. Fifth (e) the fastener is driven into the exposed bone tissue at the installation site by means of the installation tool developing and imparting a linear impulse force to the dental fastener so that it moves along the axis of the shank into the bone. Ruptured fragments of bone are allowed to backfill in the vicinity of the fastener barbs, and the incident trauma promotes osteogenesis which will eventually involve the barbs and over the course of a healing regimen will rigidly secure the fastener so that it may receive and withstand mechanical loads from a prosthesis affixed to its head, preferably at the torque-receiving aperture in the fastener head.

The fastener used with the above method may also be formed such that each barb in any one of the linear arrays of barbs of the fastener arises from a common strake emerging from the fastener shank. A leading edge of any one of the barbs may further comprise a positively or a negatively curved surface, and a trailing edge of any one of the barbs of the fastener may likewise include a positively or a negatively curved surface. A profile of any barb may further comprise a shape such as a triangle, a rectangle, a parallelogram, a square, or a rhomboid. Where a strake or a root portion of a barb defines a midplane, any barb may further comprise an arcuate membrane bending away from the midplane.

Optionally, the installation tool may develop the linear impulse force for driving the fastener into the bone by any number of means, such as the tool including a hydraulic or pneumatic actuator, or an electric solenoid. Stored mechanical energy from a cocked spring or similar elastic member held in compression or in tension may be released by a trigger mechanism in the tool to drive the fastener. Other means such as a chemical reaction may be used either to generate a gas to develop pressure against a piston, or against a rupture plate or to generate a heated gas or a heated working fluid. Boyle's Law may be utilized to generate pressure in a cylinder or an actuator to drive or impel the fastener in the direction defined by its shank axis. Rotation of the fastener is not required to procure installation conditions which promote the generation of new bone structure in the immediate vicinity of the fastener install site. Using the inventive fastener and the disclosed method of fastener insertion without rotation may reduce the interval of time between an installation procedure and an established, stable condition wherein the inventive fastener offers superior holding strength to a crown or other prosthesis affixed to it in a later course of tooth reconstruction.

Yet another set of means for generating a linear impulse force to impart to the fastener include ignition of a propellant material or a deflagration of a propellant or similar chemical. The propellant may be packaged or otherwise made available as a cartridge including a primer which is an initiator or detonator chemical material which is strain rate sensitive so that an ignition or deflagration reaction begins when a portion of the initiating material is compressed or struck sufficiently swiftly. Cartridge components may be designed to be reusable by reloading equipment, or some or all components may be furnished as single-use disposable items.

Primer compounds may include lead styphenate, barium nitrate, antimony sulfide, tetrazine, and titanium. Other initiator compounds include dinitrodihydroxydiazobenzene salt (diazinate,) various diazo, triazole, and tetrazaole compounds, dinitrbenzo-furoxan salts, potassium dinitrodenzofuroxan, perchlorate or nitrate salts of potassium, or of metal complexes of ammonium, amines or hydrazine, which an example of the latter is 2-(5-cyanotetrazolato)pentaaminecobalt III perchlorate (CP). Oxidizers for these materials may include potassium nitrate and strontium nitrate, and fuel components may include amorphous boron, or metal powders, such as zinc, aluminum, zirconium, titanium, or nickel. Inert materials such as fine ground glass may also be included to increase mechanical sensitivities to friction, shock, strain rate, or compression.

In some ceases a dental practitioner using the invention may prefer to prepare the receiving site before insertion of the fastener by creating an aperture in the outer cortical tissue of the exposed bone. In dental research and literature the internal aspect of alveolar bone is referred to using terms such as cancellous, medullary, spongy, and trabecular bone. These terms are freely interchangeable and equivalent in this specification. Thus, after exposing the bone in the vicinity of the desired installation site, the practitioner may include an intermediate step of removing cortical tissue of the exposed bone to expose trabecular tissue. The practitioner may also choose to remove some trabecular tissue as well to create a receiving site for the fastener. However, the improvement offered by the invention is to reduce or eliminate these preliminary steps in advance of installing the inventive fastener, and it is preferable that the fastener may be forced through the cortical tissue with minimal such preparations as soon as the installation site is determined and made ready.

It has been discovered that bones that are “naturally” fractured heal quicker recognized than bones that are machined such as by cutting or drilling. “Natural” fractures mean overstressing the material structure of the bone until physical rupture of the tissue initiates local cracks which propagate away from an overstressed fracture site. Besides the new surfaces created by the fracture, other cracks are created which extend orthogonal to the fracture surfaces, and these cracks tend to remain open after the initial trauma. This additional porosity in addition to the naturally occurring roughness of mechanically fractured surfaces promote blood and fluid flow and mobility of fluids in the immediate vicinity of the fracture site, and especially in cortical tissue.

In contrast, bone surfaces cut and exposed by machining tend to have much finer surface roughness, and may be burnished by the passage of a cutting face or tooth of a machine tool. Cracks which propagate from the machining operation are much shorter and finer than those made by a naturally propagating rupture surface. Machined surfaces are also more likely to be planar or complementary to each other so that they may close tightly upon each other and leave little or no gap between them. Thus a machining operation on bone leaves fewer and smaller fluid passages, resulting in reduced mobility of fluids at the site and promoting slower rates of recuperative osteogenesis after the procedure.

Local to a preparation site for an implant, mechanically fractured bone provides a larger number and variety of discontinuities and gaps between irregular surfaces created by the mechanical shock which creates the fracture, resulting in fewer barriers to fluid flow. The improved mobility of fluids at the site helps deliver more blood and nutrients and generally invigorates the area.

Since blood flow through bone tissue is known as an important factor in the rate of bone regeneration, growth, and repair, then as compared to machined or drilled surfaces, mechanically fractured bone surfaces may offer notably improved adhesion and structural strength in the vicinity of an implant, and a shortened interval of time between initial placement of the implant and a point when the implant is ready to provide full service in withstanding various chewing and clamping forces of the teeth and jaws. One healing mechanism improved by increased fluid permeability at a bone fracture site is the influx of macro-phages which release inflammatory mediators and in turn further increase blood capillary permeability.

A dental bone implant that is installed by means of a tool which imparts a linear impulse force to the implant and drives it into the bone tissue creates numerous micro-fractures having non-united surfaces. Furthermore, driving a dental implant into position will break away some bone particles such as trabecular material, and entrain them during the linear motion of the incoming implant. This finer material may get pushed into existing cavities left by the roots of the former tooth, stimulating additional repair and reconstructive activity proximal to the site and improved adhesion and ossification, providing the basis for long term mechanical stability for the implant. The accelerated healing occurs by the general stimulation of healing processes in the area even though bone particles outside the reconstruction zone are eventually consumed by osteoclasts.

Compared to the inventive implant and the linear impulse installation motion described herein, a dental implant that is installed by screwing into a drilled hole having smooth, machine cut surfaces with low fluid permeability proximal to the implant is much more likely to evince poorer blood and nutrient flow, retard bone rebuilding and regeneration, and may deleteriously promote scarring in the bone tissue and biological rejection rather than the desired union with the implant.

While certain features and aspects have been described with respect to exemplary embodiments, one skilled in the art will recognize that numerous modifications are possible. Further, while various methods and processes described herein may be described with respect to particular structural and/or functional components for ease of description, methods provided by various embodiments are not limited to any particular structural and/or functional architecture.

Hence, while various embodiments are described with or without certain features for ease of description and to illustrate exemplary aspects of those embodiments, the various components and/or features described herein with respect to a particular embodiment may be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A fastener comprising
a shank with a head at its first end and a point at its second end,
said head further comprising a torque receiving aperture,
said shank defining an axis,
said fastener further comprising
a radially spaced apart series of linear arrays of barbs spaced apart along said axis.

2. The fastener of claim 1, wherein said torque receiving aperture comprises threads.

3. The fastener of claim 1, wherein said torque receiving aperture is a hexagonal aperture.

4. The fastener of claim 1, wherein each barb in any one of said linear arrays arises from a common strake emerging from said shank.

5. The fastener of claim 1, wherein a leading edge of any one of said barbs further comprises a positively curved surface.

6. The fastener of claim 1, wherein a trailing edge of any one of said barbs further comprises a negatively curved surface.

7. The fastener of claim 1, wherein a profile of any one of said barbs further comprises a shape selected from the set of shapes consisting of:
a triangle, a rectangle, a parallelogram, a square, and a rhomboid.

8. The fastener of claim 1, wherein any one of said linear arrays of barbs defines a plane passing through said axis of said shank, and any one barb within said linear array of barbs further comprises an arcuate membrane bending away from said plane.

9. The fastener of claim 1, wherein all of said barbs in any one linear array of barbs arise from a common strake.

10. The fastener of claim 1, wherein a number of said linear arrays is “n,” a spacing pitch for said barbs in said linear array is a length dimension “p₁,” and an axial offset between a first barb in a first linear array and a first barb in a radially adjacent second linear array is a length dimension “p₂,” where the value of “p₂,” is the value of “p₁” divided by “n.”

11. The fastener of claim 10, wherein a plurality of barbs are arranged in a continuous helix.

12. A method for installing a dental implant, comprising the steps of:
a. removing material to expose bone tissue at a desired installation site,
b. irrigating said installation site with a disinfectant solution,
c. providing a fastener comprising:
a shank with a head at its first end and a point at its second end,
said head further comprising a torque receiving aperture,
said shank defining an axis,
said fastener further comprising
a radially spaced apart series of linear arrays of barbs spaced apart along said axis,
d. providing an installation tool capable of imparting a linear impulse force to said fastener, and
e. driving said fastener, by means of said installation tool imparting said linear impulse force to said fastener, along said axis of said shank into said exposed bone tissue at said installation site.

13. The method of claim 12, further comprising a step after step (a) of removing infected tissue found at said installation site.

14. The method of claim 12, further comprising a step after step (b) of removing cortical tissue of said exposed bone to expose trabecular tissue.

15. The method of claim 12, wherein said installation tool develops said linear impulse force from an energy source selected from the set of energy sources consisting of:
a hydraulic actuator, a pneumatic actuator, an electric solenoid, an elastic member held in compression, an elastic member held in tension, a chemical reaction, a gas evolved from a chemical reaction, a heated gas, an ignition of a propellant material, and a deflagration.

16. The method of claim 12, wherein each barb in any one of said linear arrays of barbs of said fastener arises from a common strake emerging from said shank.

17. The method of claim 12, wherein a leading edge of any one of said barbs of said fastener further comprises a positively curved surface.

18. The method of claim 12, wherein a trailing edge of any one of said barbs of said fastener further comprises a negatively curved surface.

19. The method of claim 12, wherein a profile of any one of said barbs of said fastener further comprises a shape selected from the set of shapes consisting of:
a triangle, a rectangle, a parallelogram, a square, and a rhomboid.

20. The method of claim 12, wherein any one of said linear arrays of barbs of said fastener defines a plane passing through said axis of said shank of said fastener, and any one barb within said linear array of barbs further comprises an arcuate membrane bending away from said plane.
